(19) United States
(12) Patent Application Publication
(10) Pub. No.: US 2021/0377405 A1
(43) Pub. Date: Dec. 2, 2021

(54) INFORMATION PROCESSING SYSTEM TO REDUCE TROUBLE OF INPUT OPERATIONAL SETTING

(71) Applicant: FUJIFILM Business Innovation Corp., Tokyo (JP)

(72) Inventors: Wenjin ZHANG, Kanagawa (JP); Dawei YANG, Kanagawa (JP)

(73) Assignee: FUJIFILM Business Innovation Corp., Tokyo (JP)

(21) Appl. No.: 17/120,250

(22) Filed: Dec. 13, 2020

(30) Foreign Application Priority Data
May 28, 2020 (JP) 2020-093609

(51) Int. Cl. H04N 1/00; H04N 1/44

(52) U.S. Cl. CPC H04N 1/00514; H04N 1/4433; H04N 1/4426

(57) ABSTRACT

An information processing system including: a network device, use of which by a user is permitted beforehand for a period set beforehand; and an information processing apparatus that manages first information for identifying the user and second information for identifying the network device in connection with each other, wherein the information processing apparatus includes a first processor configured to prepare a temporary account in correlation with the network device corresponding to the second information in a case where an application for use including the first information and the second information is received, and notify information to be used to authenticate the prepared temporary account to a portable terminal used by the user to make the application, and the network device includes a second processor configured to apply operational setting prepared in the portable terminal for the temporary account in a case where the information to be used to authenticate the temporary account is acquired.

### CROSS-REFERENCE TO RELATED APPLICATIONS

This application is based on and claims priority under 35 USC 119 from Japanese Patent Application No. 2020-093609 filed May 28, 2020.

### BACKGROUND

### (i) Technical Field

The present disclosure relates to an information processing system.

### (ii) Related Art

There is an increasing demand for sharable offices (hereinafter referred to as “shared offices”) along with the spread of a variety of ways of working. Fixtures shared by users are installed in the shared offices. One example of the fixtures is an image forming apparatus that provides a plurality of functions such as printing, copying, faxing, and scanning.

An example of such an apparatus is described in Japanese Unexamined Patent Application Publication No. 2017-184286.

### SUMMARY

Users of the shared offices which are rented by the month or used on a metered system change frequently compared to the existing offices which are rented by the year. Therefore, it is difficult to register beforehand information on the users, operational settings, etc. in all the network devices such as image forming apparatuses in the shared offices. As a result, the users are required to individually input operational settings etc. each time the users use the network devices, which is burdensome to the users.

Aspects of non-limiting embodiments of the present disclosure relate to reducing the trouble of inputting operational settings compared to the case where information on users and operational settings are stored in a network device in preparation for common use of the network device by unspecified users.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a network device, use of which by a user is permitted beforehand for a period set beforehand; and an information processing apparatus that manages first information for identifying the user and second information for identifying the network device in connection with each other, wherein the information processing apparatus includes a first processor configured to prepare a temporary account in correlation with the network device corresponding to the second information in a case where an application for use including the first information and the second information is received, and notify information to be used to authenticate the prepared temporary account to a portable terminal used by the user to make the application, and the network device includes a second processor configured to apply operational setting prepared in the portable terminal for the temporary account in a case where the information to be used to authenticate the temporary account is acquired.

### BRIEF DESCRIPTION OF THE DRAWINGS

Exemplary embodiments of the present disclosure will be described in detail based on the following figures, wherein:

FIG. 1 illustrates an example of the configuration of a system that is used to manage a shared office;

FIG. 2 illustrates an example of the configuration of an image forming apparatus;

FIG. 3 illustrates a part of data stored in a storage device;

FIG. 4 illustrates some of functions provided by a control unit;

FIG. 5 illustrates an example of the configuration of a portable terminal;

FIG. 6 illustrates a part of data stored in a storage device;

FIG. 7 illustrates some of functions provided by a control unit;

FIG. 8 illustrates an example of the configuration of a management server;

FIG. 9 illustrates a part of data stored in a storage device;

FIG. 10A illustrates an example of the data structure of registered information on devices that may be used;

FIG. 10B illustrates an example of the data structure of registered information on users that may use the devices;

FIG. 11 illustrates some of functions provided by a control unit;

FIG. 12 illustrates processing operation of a management system that is used in a first exemplary embodiment;

FIG. 13 illustrates processing operation of a management system that is used in a second exemplary embodiment;

FIG. 14 illustrates processing operation of a management system that is used in a third exemplary embodiment;

FIG. 15 illustrates an example of a screen displayed on a display unit in the case where setting information etc. to be transmitted to the image forming apparatus is designated;

FIG. 16 illustrates processing operation of a management system that is used in a fourth exemplary embodiment;

FIG. 17 illustrates another example of the data structure of registered information on users that may use the devices;

FIG. 18 illustrates processing operation of a management system that is used in a fifth exemplary embodiment;

FIG. 19 illustrates processing operation of a management system that is used in a sixth exemplary embodiment; and

FIG. 20 illustrates processing operation of a management system that is used in a seventh exemplary embodiment.

### DETAILED DESCRIPTION

Exemplary embodiments will be described in detail below with reference to the accompanying drawings.

### First Exemplary Embodiment

### System Configuration

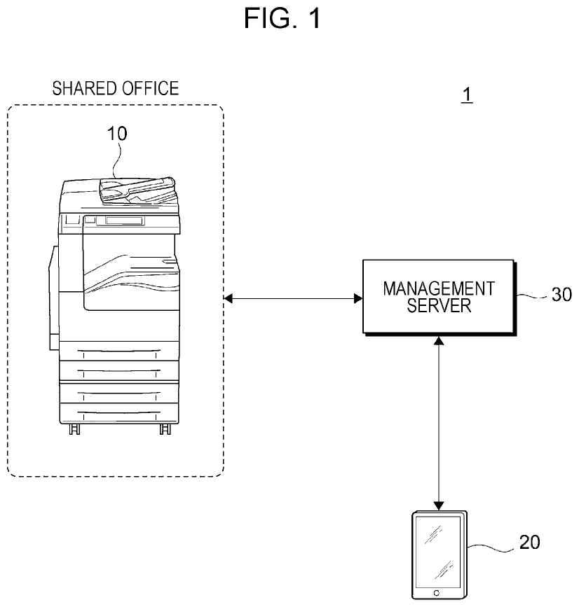

FIG. 1 illustrates an example of the configuration of a system that is used to manage a shared office. A management system 1 illustrated in FIG. 1 is constituted as a cloud system, for example.

The management system 1 according to the present exemplary embodiment is composed of an image forming apparatus 10 to be shared by users of the shared office, a portable terminal 20 carried by a user, and a server (hereinafter referred to as a “management server”) 30 that manages use of the image forming apparatus 10.

The image forming apparatus 10 and the management server 30 according to the present exemplary embodiment are examples of an information processing system.

In the case of the management system 1 illustrated in FIG. 1, there is one shared office, namely a shared office X. However, there may be two or more shared offices that compose the management system 1. One business operator may operate a plurality of shared offices. In the case of the present exemplary embodiment, a business operator that operates the shared office X and a business operator that operates the management server 30 are the same as each other. However, a business operator that operates the shared office X and a business operator that operates the management server 30 may be different from each other.

In the case of FIG. 1, one image forming apparatus 10 is disposed in the shared office X. However, a plurality of image forming apparatuses 10 may be disposed in the shared office X.

The image forming apparatus 10 according to the present exemplary embodiment is connected to the management server 30 through a network. In this sense, the image forming apparatus 10 is an example of a network device. Examples of the network include the Internet.

In the case where the management server 30 is present in the shared office X, however, the image forming apparatus 10 is connected to the management server 30 by way of a local area network (LAN). In this case, the LAN is not limited to a wired LAN, and may be a wireless LAN.

In the case of the present exemplary embodiment, the image forming apparatus 10 disposed in the shared office has a plurality of functions such as printing, copying, faxing, and scanning. The image forming apparatus 10 of this type is also referred to as a “multi-function device”.

In the case of the present exemplary embodiment, the image forming apparatus 10 disposed in the shared office has functions that are the same as or equivalent to those of an image forming apparatus 10 disposed at a company etc. to which the users belong. It is desirable that the image forming apparatus 10 disposed in the shared office should be the same as the image forming apparatus 10 disposed at the company etc. to which the users belong.

It is desirable that the image forming apparatus 10 disposed in the shared office and the image forming apparatus 10 disposed at the company to which the users belong should be image forming apparatuses 10 having equivalent functions and manufactured by the same manufacturer.

However, an image forming apparatus 10 manufactured by a different manufacturer may be mixed in the image forming apparatuses used in the management system 1. It is not necessary that all the image forming apparatuses 10 used in the management system 1 should be products of a single manufacturer if the image forming apparatuses 10 etc. have a function of securing compatibility for settings for equivalent functions, for example.

It is not necessary that the users who use the shared office should belong to a company etc. That is, the users may use the shared office as individuals. In the case of the users as individuals, the image forming apparatus 10 may have a performance that is equivalent to or better than that of the image forming apparatus 10 disposed in any shared office, printers that the users own as individuals, etc.

The management server 30 according to the present exemplary embodiment provides a service of applying information on operational settings stored in the portable terminal 20 carried by the user to a specific image forming apparatus 10 disposed in the shared office. Specifically, the management server 30 executes a process of connecting between the user who may use the image forming apparatus 10 in the shared office and the image forming apparatus 10 as a target of use, to enable writing of the setting information from the portable terminal 20 into the image forming apparatus 10.

While one management server 30 is provided in the case of FIG. 1, the management server 30 may be implemented by a plurality of servers disposed in a distributed manner on the Internet. The management server 30 may be of an on-premise type or a cloud type. The management server 30 is an example of the information processing apparatus.

The management server 30 according to the present exemplary embodiment is also capable of communicating with the portable terminal 20 carried by the user. A mobile communication system, a wireless LAN, or Bluetooth (registered trademark) is used for communication between the management server 30 and the portable terminal 20.

In the case of the present exemplary embodiment, setting information etc. that is peculiar to the user and provided to the image forming apparatus 10 in the shared office is deleted from the image forming apparatus 10 each time use by the user is ended.

In the case of the present exemplary embodiment, information on a temporary user is deleted from the management server 30 when the period of use of the shared office by the user is terminated.

In the example in FIG. 1, the portable terminal 20 is a smartphone. However, the portable terminal 20 may be a tablet terminal, a cellular phone, or a wearable terminal that includes a display section. Near-field wireless communication such as a wireless LAN, Near Field Communication (NFC), or Bluetooth is used for communication between the portable terminal 20 and the image forming apparatus 10. A mobile communication system may also be used for communication between the portable terminal 20 and the image forming apparatus 10.

While one portable terminal 20 is illustrated in FIG. 1, a plurality of portable terminals 20 may also be used. In the case of the present exemplary embodiment, the portable terminal 20 is an example of a portable terminal.

### Configuration of Image Forming Apparatus

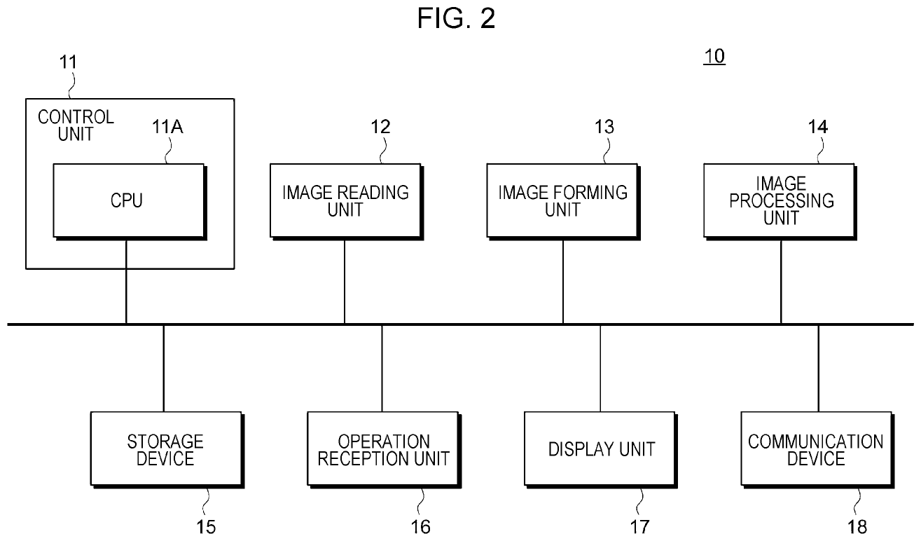

FIG. 2 illustrates an example of the configuration of the image forming apparatus 10.

The image forming apparatus 10 includes: a control unit 11 that controls operation of the entire apparatus; an image reading unit 12 that reads an image of a document; an image forming unit 13 that forms an image on paper as an example of a recording medium; an image processing unit 14 that performs processing such as color correction and tone correction on image data; a storage device 15 that stores image data etc.; an operation reception unit 16 that receives an operation by a user; a display unit 17 that is used to display a user interface screen etc.; and a communication device 18 that achieves communication via a telephone line, a local area network (LAN) cable, etc. The control unit 11 and the other processing sections are connected to each other using a signal line or a bus.

The control unit 11 includes a central processing unit (CPU) 11A, a read only memory (ROM) that stores firmware, a basic input output system (BIOS), etc., and a random access memory (RAM) that is used as a work area. The control unit 11 functions as a so-called computer. The CPU 11A is an example of a second processor.

The image reading unit 12 is a so-called scanner, and supports both a mode in which an image is read while moving a reading section relative to a document in a stationary state and a mode in which an image is read while moving a document relative to the reading section in a stationary state.

The image forming unit 13 is a unit that forms an image on a recording medium such as paper, and includes a mechanism corresponding to the forming system. Examples of a recording material include toner and ink.

The image processing unit 14 is constituted of a dedicated processor, a processing circuit, etc. for processing image data.

The storage device 15 is constituted of a hard disk device (HDD) or a semiconductor memory, for example. The storage device 15 stores image data read through the image reading unit 12, document data and image data received through communication with an external device, FAX data received through facsimile communication, information that specifies the image forming apparatus, temporary user information received from the portable terminal 20 (see FIG. 1), information (hereinafter referred to as “temporary user authentication information”) for authenticating a temporary user received from the management server 30 (see FIG. 1), etc.

The operation reception unit 16 includes a film-like touch sensor disposed on a surface of the display unit 17, switches, buttons, etc. The film-like touch sensor is so transparent as not to hinder the viewability of information displayed on the display unit 17.

The display unit 17 is a liquid crystal display or an organic electro-luminescence (EL) display, for example.

The communication device 18 is constituted of a communication interface that conforms to various types of standards. In the case of the present exemplary embodiment, the communication device 18 is used for communication with the portable terminal 20 and the management server 30.

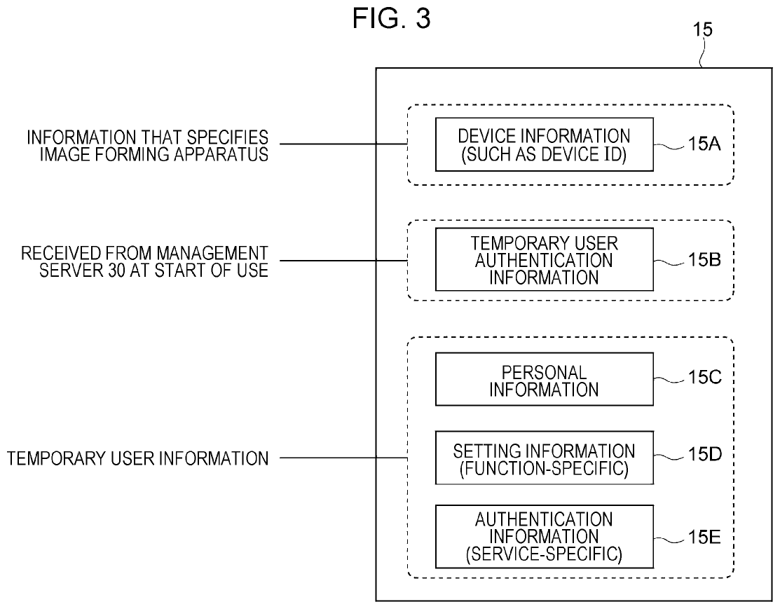

FIG. 3 illustrates a part of data stored in the storage device 15. FIG. 3 illustrates data associated with a management service for the shared office.

Device information 15A is information that specifies the image forming apparatus 10. The device information 15A is stored in the storage device 15 irrespective of use of the image forming apparatus 10 by the user. The device information 15A according to the present exemplary embodiment includes identification information (hereinafter referred to as a “shared office ID”) that specifies the shared office and identification information (hereinafter referred to as a “device ID”) that specifies the image forming apparatus 10. These IDs are used to uniquely specify the image forming apparatus 10 as a target for the management service. Besides, the device information 15A may include the name of the shared office, the model name of the image forming apparatus 10, a list of identification information (hereinafter referred to as a “user ID”) that specifies the users who may use the image forming apparatus 10. The user ID is an example of first information.

Temporary user authentication information 15B is information that is used to authenticate a temporary user who uses the image forming apparatus 10, and is received from the management server 30 at the start of use by the user. Examples of the temporary user authentication information 15B include a password. The password is composed of characters and numerals, and also called “code number”. The temporary user authentication information 15B may also be displayed as a barcode or a Quick Response (QR) code (registered trademark).

The temporary user authentication information 15B is generated for each temporary user. The temporary user is generated for each contract that determines a period of use or a condition for use. Therefore, the user as an identical natural person is managed as different temporary users under different contracts. Thus, different temporary user authentication information 15B may be used for each use by the same temporary user.

Personal information 15C, function-specific setting information 15D, and service-specific authentication information 15E are examples of the temporary user information, and are stored in the storage device 15 during use of the image forming apparatus 10 by the user.

The personal information 15C is information that specifies the user. Examples of the personal information 15C include the name, the name of a company to which the user belongs, and the mail address of the user.

The setting information 15D is information that prescribes execution of functions of the image forming apparatus 10 and that is stored in the portable terminal 20 by the temporary user. The setting information 15D is prepared for each function.

For example, the setting information 15D corresponding to the printing function includes setting for double-sided printing, setting for color printing, setting for printing in which a plurality of pages are compiled into a single sheet of paper, setting for the upper limit of the number of sheets to be printed at a time, etc. The setting information 15D corresponding to the scanner function includes setting for the resolution, setting for the file format of image data optically read from a document, setting for the saving destination, etc. The setting information 15D corresponding to the faxing function includes setting for the transmission destination of image data optically read from a document etc.

The setting information 15D corresponding to the confidential box function includes setting for a box number that specifies a storage region, a password, etc. The confidential box is a storage region provided exclusively for a specific user. Access to the confidential box is allowed for only authorized users.

In the case where the transmission destination for the scanner function or the storage region for the confidential box function is provided as a storage service on the cloud, information for authentication required to use the storage service is stored in the storage device 15 as the authentication information 15E.

Besides the above, the setting information 15D also includes setting for a job flow function of invoking a sequence of operations to be applied to documents accumulated in the confidential box.

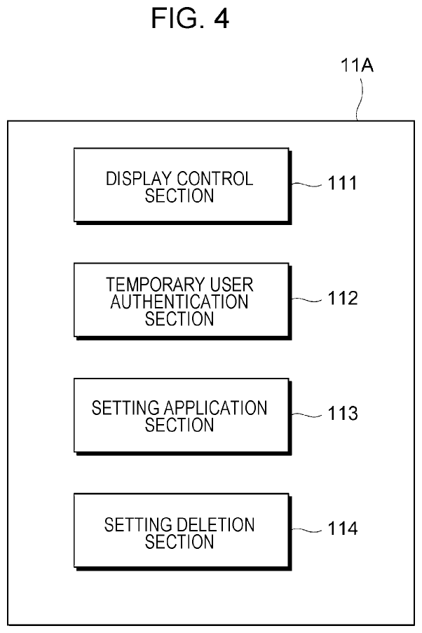

FIG. 4 illustrates some of functions provided by the control unit 11 (see FIG. 2). The functions illustrated in FIG. 4 include: a display control section 111 that controls display of the device information 15A (see FIG. 3) on the display unit 17 (see FIG. 2); a temporary user authentication section 112 that authenticates whether or not the temporary user has the authority to use the image forming apparatus 10 (see FIG. 1); a setting application section 113 that applies the setting information 15D and the authentication information 15E to the temporary user; and a setting deletion section 114 that deletes the setting information 15D and the authentication information 15E from the storage device 15 when use by the temporary user is terminated. These functions are provided through execution of a program by the CPU 11A.

### Portable Terminal

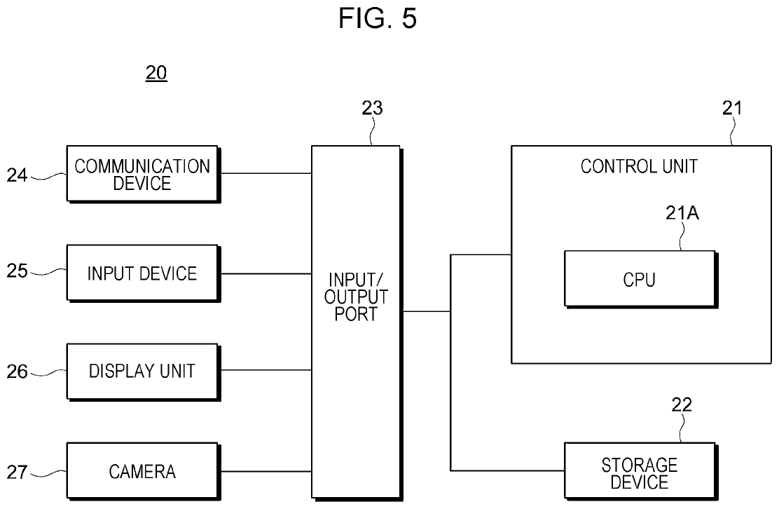

FIG. 5 illustrates an example of the configuration of the portable terminal 20.

The portable terminal 20 includes a control unit 21 that controls operation of the entire device, a storage device 22 that stores data, an input/output port 23, a communication device 24, an input device 25, a display unit 26, and a camera 27. The control unit 21 and the other processing sections are connected to each other using a signal line or a bus.

The control unit 21 includes a CPU 21A, a ROM that stores a BIOS etc., and a RAM that is used as a work area. The control unit 21 functions as a so-called computer. The CPU 21A is an example of a processor.

The storage device 22 is constituted of a semiconductor memory, for example. The storage device 22 also stores firmware and other programs, besides the management data.

The input device 25 includes a film-like touch sensor disposed on a surface of the display unit 26, switches, buttons, etc., for example.

The display unit 26 is a liquid crystal display or an organic EL display, for example.

The camera 27 is used to read a barcode and a QR code.

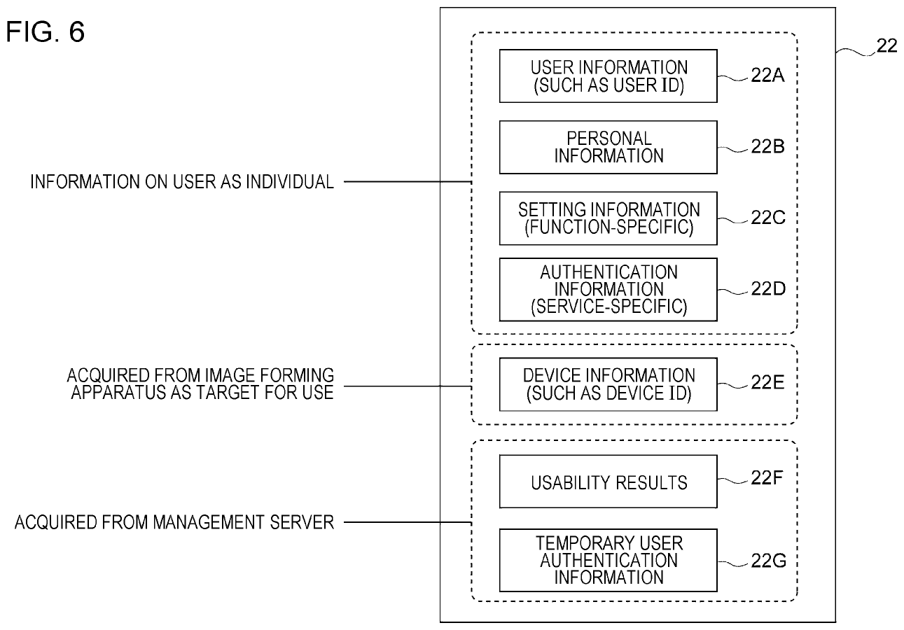

FIG. 6 illustrates a part of data stored in the storage device 22. FIG. 6 illustrates data associated with a management service for the shared office.

User information 22A, personal information 22B, function-specific setting information 22C, and service-specific authentication information 22D are information on the user as an individual, and are stored in the storage device 22 irrespective of use of the image forming apparatus 10 by the user.

The user information 22A according to the present exemplary embodiment includes identification information (i.e. “user ID”) that specifies the user who uses the shared office, identification information (i.e. “device ID”) that specifies the image forming apparatus 10 which may be used, etc. The device ID is an example of second information.

The personal information 22B is original information of the personal information 15C (see FIG. 3). The personal information 22B includes the name of the user, the name of a company to which the user belongs, the mail address of the user, etc. The setting information 22C is original information of the setting information 15D (see FIG. 3). The setting information 22C includes a mail list and a group mail list to be used as destinations. The mail lists include the names, departments, mail addresses, etc. of the destinations.

The authentication information 22D is original information of the authentication information 15E (see FIG. 3).

Device information 22E is information acquired from the image forming apparatus 10 as a target of use. The device information 22E corresponds to the device information 15A (see FIG. 3).

Usability results 22F and temporary user authentication information 22G are information acquired from the management server 30 (see FIG. 1).

The usability results 22F are the results of a determination as to whether or not the user may use the image forming apparatus 10 that the user is attempting to operate, and are given from the management server 30.

The temporary user authentication information 22G is information required for authentication executed prior to the start of use of the image forming apparatus 10 by the user, and is given from the management server 30 in the case where use of the image forming apparatus 10 by the user is allowed.

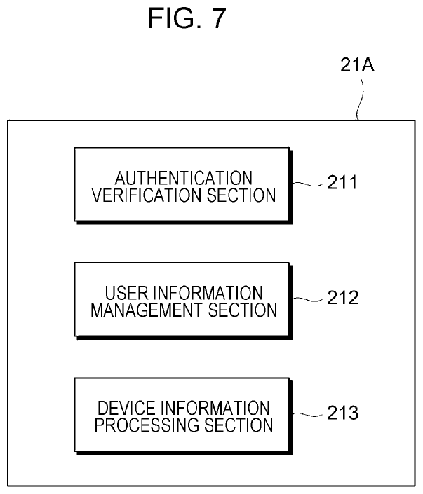

FIG. 7 illustrates some of functions provided by the control unit 21 (see FIG. 5). The functions illustrated in FIG. 7 include: an authentication verification section 211 that verifies whether the user who operates the portable terminal 20 has the authority to use an application program (hereinafter referred to as an “app”) for managing information on the user as an individual; a user information management section 212 that manages information on the user as an individual; and a device information processing section 213 that analyzes device information acquired from the image forming apparatus 10. These functions are provided through execution of a program by the CPU 21A.

The authentication verification section 211 may also be used for a function of unlocking the portable terminal 20, for example. The authentication verification section 211 authenticates the user using a personal identification number (PIN) code or biological information, for example.

The user information management section 212 is used to register and change personal information, function-specific authentication information, and service-specific authentication information.

The device information processing section 213 retrieves device information by analyzing image data captured by the camera 27 (see FIG. 5) or data received by the communication device 24 (see FIG. 5).

### Management Server

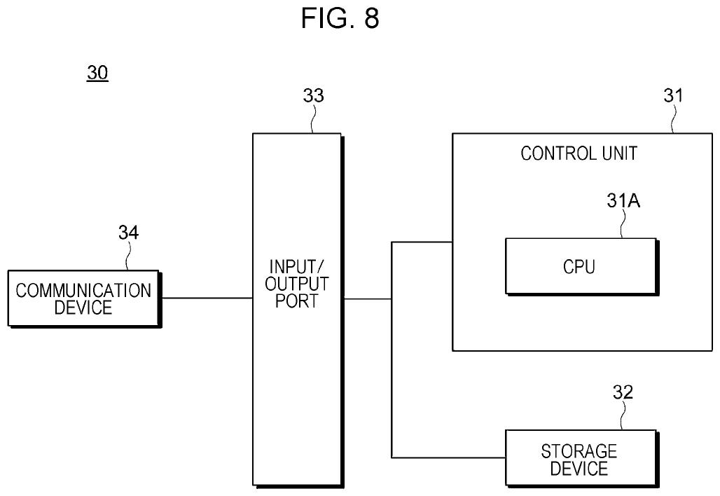

FIG. 8 illustrates an example of the configuration of the management server 30.

The management server 30 includes a control unit 31 that controls operation of the entire device, a storage device 32 that stores data related to management of the shared office, an input/output port 33, and a communication device 34.

The control unit 31 includes a CPU 31A, a ROM that stores a BIOS etc., and a RAM that is used as a work area. The control unit 31 functions as a so-called computer. The CPU 31A is an example of a first processor.

The storage device 32 is constituted of a hard disk device or a semiconductor memory, for example. The storage device 32 also stores an operation system and other programs, besides information associated with the management service for the shared office.

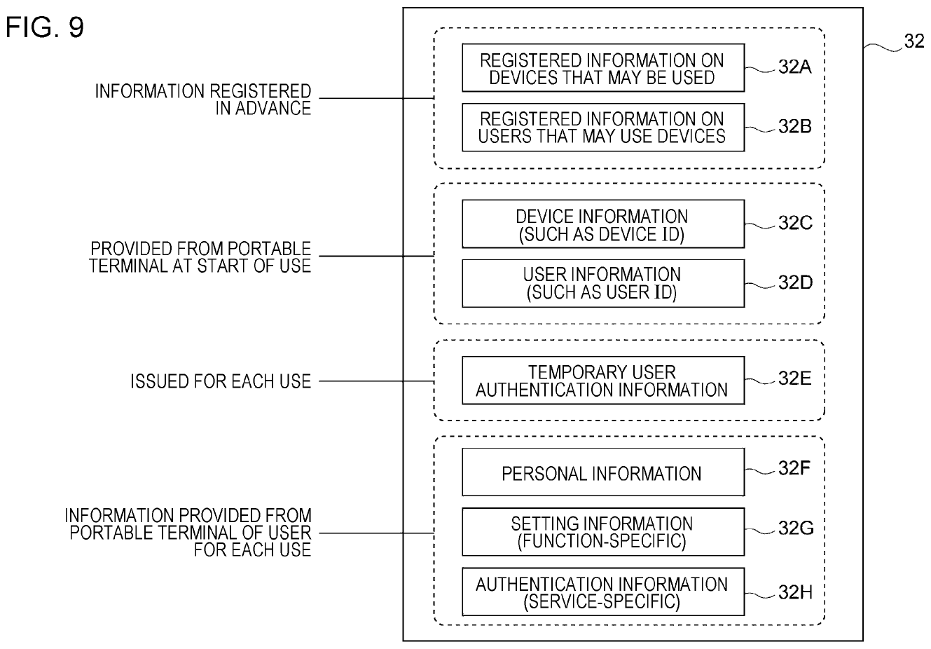

FIG. 9 illustrates a part of data stored in the storage device 32. FIG. 9 illustrates data associated with the management service for the shared office.

Of the data illustrated in FIG. 9, registered information 32A on devices that may be used and registered information 32B on users that may use the devices are registered in advance.

The registered information 32A on devices that may be used is information that specifies the image forming apparatus 10 which is disposed in the shared office, and is registered by a business operator that operates the shared office.

The registered information 32B on users that may use the devices is information that specifies users who are allowed to use the shared office, and is registered in the case where a user applies for use of the shared office.

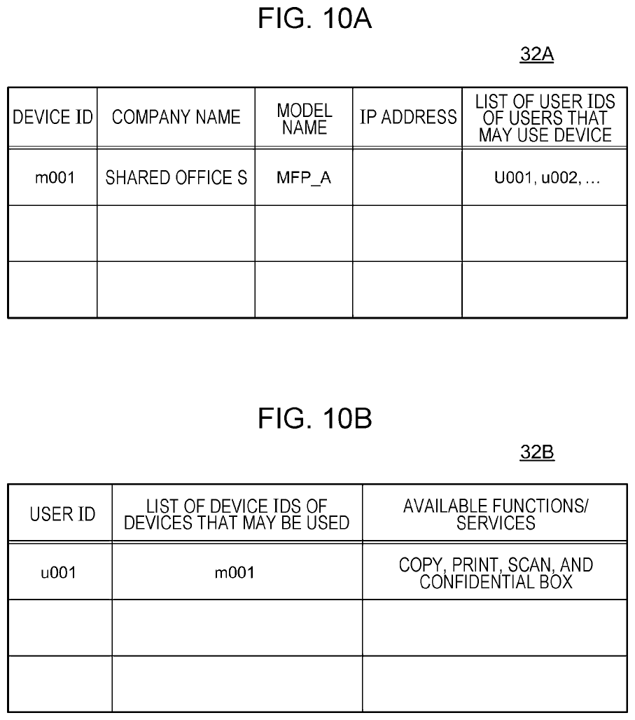

FIGS. 10A and 10B illustrate an example of the data structure of the registered information 32A on devices that may be used and the registered information 32B on users that may use the devices, respectively. FIG. 10A illustrates an example of the data structure of the registered information 32A. FIG. 10B illustrates an example of the data structure of the registered information 32B.

The registered information 32A illustrated in FIG. 10A includes a device ID, a company name, a model name, an IP address, and a list of user IDs of users that may use the device. Such information is given from a business operator that operates the shared office as discussed earlier. The user IDs connected with the device ID are determined in accordance with a contract with the users. For example, the registered information 32A is registered in the case where the user may use only the image forming apparatuses 10 which are disposed in shared offices operated by a specific business operator or located in a specific region.

The registered information 32B illustrated in FIG. 10B includes a user ID, a list of device IDs of devices that may be used, and available functions and services.

The list of device IDs is also registered in the case where a contract with the user places a constraint on the image forming apparatuses 10 that may be used.

The available functions and services are also registered in the case where a contract with the user places a constraint. In the example in FIG. 10B, copy, print, scan, and confidential box are connected with the user ID.

FIG. 9 is described again.

Device information 32C and user information 32D are information provided from the portable terminal 20 at the start of use of the image forming apparatus 10 in the shared office. The device information 32C is information acquired by the portable terminal 20 from the image forming apparatus 10 which is operated by the user. The user information 32D is information stored in the portable terminal 20 which is operated by the user, and received by the management server 30 together with the device information 32C. Such information is collated with the registered information 32A and 32B, and used to determine whether not the user may use the image forming apparatus 10.

Temporary user authentication information 32E is information issued in the management server 30 to the user who is permitted for use as a temporary user. The temporary user authentication information 32E according to the present exemplary embodiment is targeted for all the device IDs stored in the registered information 32B. In other words, the temporary user authentication information 32E according to the present exemplary embodiment may be commonly used by a plurality of image forming apparatuses 10. The temporary user authentication information 32E may be generated only once at the time of application for a first use within a period of use determined by a contract, or may be generated at each time of use within a period of use determined by a contract.

Personal information 32F, function-specific setting information 32G, and service-specific authentication information 32H are information acquired from the portable terminal 20 of the user for each use.

The personal information 32F corresponds to the personal information 15C (see FIG. 3). The function-specific setting information 32G corresponds to the function-specific setting information 15D (see FIG. 3). The service-specific authentication information 32H corresponds to the service-specific authentication information 15E.

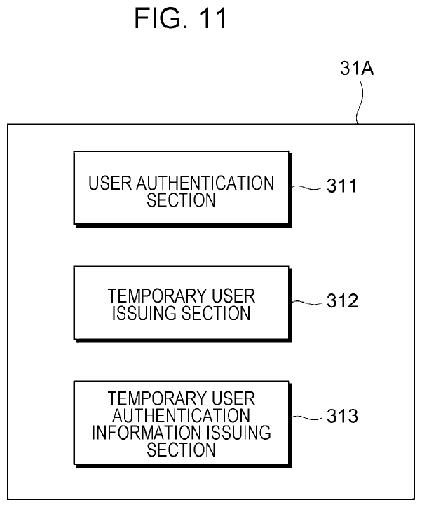

FIG. 11 illustrates some of functions provided by the control unit 31 (see FIG. 8). The functions illustrated in FIG. 11 include: a user authentication section 311 that determines whether or not use of the image forming apparatus 10 (see FIG. 1) in the shared office by the user who operates the portable terminal 20 (see FIG. 1) is allowed; a temporary user issuing section 312 that issues a temporary user for using the image forming apparatus 10 to a user who is successfully authenticated; and a temporary user authentication information issuing section 313. These functions are provided through execution of a program by the CPU 31A.

The user authentication section 311 authenticates whether or not the user who is an applicant has the authority to use the image forming apparatus 10 in the shared office on the basis of the device information 32C (see FIG. 9) and the user information 32D (see FIG. 9) included in an application for use received from the portable terminal 20. Specifically, the user authentication section 311 collates the received device information 32C and user information 32D with the registered information 32A and 32B. In the case where the received device information 32C and user information 32D are included in the registered information 32A and 32B, use of the image forming apparatus 10 by the user who is an applicant is permitted.

In the case where the received device information 32C and user information 32D are not included in the registered information 32A and 32B, on the other hand, the user authentication section 311 determines that the user is not a target for the service according to the present exemplary embodiment.

The temporary user issuing section 312 issues a temporary user in the case where the user who is an applicant is a target for the service according to the present exemplary embodiment. The temporary user is commonly used for all the image forming apparatuses 10 that may be used by the user who is an applicant. Thus, the generated temporary user is not limited to the image forming apparatus 10 which is operated for use by the user. Setting information that is peculiar to the user and stored in the portable terminal 20 is applied to the generated temporary user.

The temporary user authentication information issuing section 313 issues temporary user authentication information to allow use of a specific image forming apparatus 10 by a temporary user. In the case of the present exemplary embodiment, the temporary user authentication information issuing section 313 issues different temporary user authentication information for each use of the image forming apparatus 10 by the user, and provides the temporary user authentication information to the image forming apparatus 10 and the portable terminal 20.

### Flow of Processing Operation

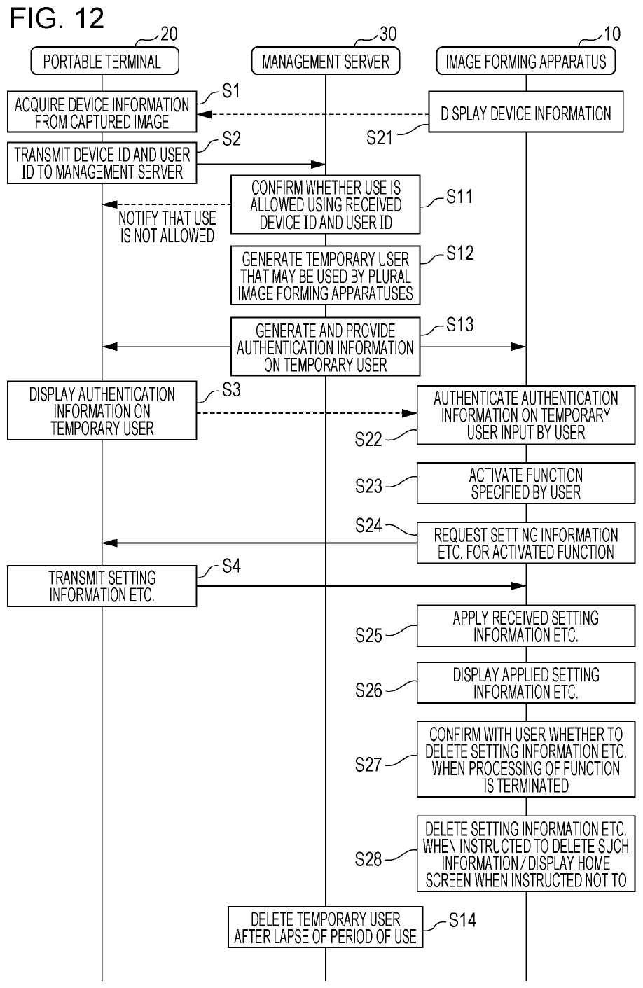

FIG. 12 illustrates processing operation of the management system 1 that is used in the first exemplary embodiment. The symbol “S” in the drawing signifies a step.

As a premise for the process illustrated in FIG. 12, the device information 32C (see FIG. 9) which specifies the image forming apparatus 10 and the user information 32D (see FIG. 9) on the user who uses the service are registered in the management server 30.

When the user makes a contract to use the shared office, for example, the business operator which operates the shared office adds a user ID that specifies the user who is a party to the contract to a list of user IDs of users who may use the devices in the registered information 32A (see FIG. 9).

A device ID that specifies the image forming apparatus is added to a list of device IDs of devices that may be used in the registered information 32B prior to use of the present service.

Setting information etc. to be applied during use as a temporary user is registered in the portable terminal 20 of the user who uses the shared office prior to use of the present service.

In a sequence of processes, the user who uses the shared office instructs the image forming apparatus 10 to display the device information 32C. The image forming apparatus 10 which has been operated displays the device information 32C on the display unit 17 (see FIG. 2) (step 21). In the case of the present exemplary embodiment, the device information 32C is displayed as a barcode or a QR code. The device information 32C may also be displayed as a character string on the display unit 17.

Incidentally, in the case where the user provides an instruction to acquire the device information 32C through wireless communication, the image forming apparatus 10 provides the device information to a portable terminal 20 that has become able to communicate with the apparatus itself.

In the case of FIG. 12, the device information is displayed on the display unit 17, and thus the user captures an image of the barcode etc. displayed on the display unit 17 using the camera 27 (see FIG. 5) of the portable terminal 20. When the image is captured, the portable terminal 20 acquires the device information from the captured image (step 1). In the case where the image data include a character string, text data are acquired through an optical character recognition (OCR) process.

In the case of the present exemplary embodiment, the portable terminal 20 transmits the user ID, which is added to the device ID acquired from the captured image, to the management server 30 (step 2). The user ID is stored in the portable terminal 20.

When the device ID and the user ID are received from the portable terminal 20, the management server 30 confirms whether or not use is allowed using the received device ID and user ID (step 11). Whether or not use is allowed is confirmed for each of the device ID and the user ID. The management server 30 also confirms the state of use and the state of communication of the image forming apparatus 10 as a target. This is because the present exemplary embodiment requires communication between the management server 30 and the image forming apparatus 10 to be enabled.

In the case where any of the received device ID and user ID is not registered, the management server 30 notifies the portable terminal 20 that use is not allowed.

In the case where use is allowed, the management server 30 generates a temporary user that may be used by a plurality of image forming apparatuses 10 (step 12). After that, management of the temporary user by the management server 30 is started. The temporary user is stored and held in the management server 30 during a period of use determined by the contract with the user.

Next, the management server 30 generates and provides authentication information on the generated temporary user (step 13). The authentication information may be invariable while management of the temporary user is continued in some cases, and may be changed each time the user applies for use of the image forming apparatus 10 in other cases.

The authentication information is provided to the plurality of image forming apparatuses 10 which may be used and the portable terminal 20 which applied for use. The authentication information is required for authentication when use of the image forming apparatus 10 is actually started. In the case of the present exemplary embodiment, information for accessing the portable terminal 20 of the user who requests an operation is also provided from the management server 30 to the image forming apparatuses 10. For example, personal information is provided.

When the authentication information on the temporary user is received, the portable terminal 20 displays the received authentication information on the temporary user on the display unit 26 (see FIG. 5) (step 3).

This is because it is assumed that the user manually inputs the authentication information on the temporary user to the image forming apparatus 10 in the present exemplary embodiment. Thus, display in step 3 is not necessary in the case where the image forming apparatus 10 is notified of the authentication information on the temporary user through NFC etc. Even in such a case, however, an operation requested from the user to input the authentication information is displayed on the display unit 26 (see FIG. 5) of the portable terminal 20 or the display unit 17 (see FIG. 2) of the image forming apparatus 10.

After that, the image forming apparatus 10 authenticates the authentication information on the temporary user input by the user (step 22).

If the input authentication information is wrong, the user is prompted to input correct authentication information. The subsequent processes are not executed unless the authentication is successfully performed.

It is assumed that the authentication is successfully performed. Next, the image forming apparatus 10 activates a function specified by the user on an operation screen displayed on the display unit 17 (step 23). For example, the scanner function is activated.

The image forming apparatus 10 requests the portable terminal 20 for the setting information etc. for the activated function using the personal information which is acquired together with the authentication information on the temporary user (step 24).

Upon receiving this request, the portable terminal 20 transmits the requested setting information etc. to the image forming apparatus 10 which sent the request (step 4). In the case of the present exemplary embodiment, the temporary user is generated for all the image forming apparatuses 10 that may be used. However, the setting information is transmitted to only the image forming apparatus 10, use of which is requested by the user.

The image forming apparatus 10 applies the received setting information etc. (step 25), and displays the applied setting information etc. on the display unit 17 (step 26). In this manner, in the case of the present exemplary embodiment, the setting information etc. for the specified function is applied and displayed on the display unit 17.

For example, in the case of the scanner function, whether image data on a document are taken in in monochrome or in color, the resolution value, the file format of the image data, etc. are displayed on the display unit 17 as the setting information for the temporary user. In the case where the displayed setting is used as it is, it is not necessary for the user to manually input instructions for the individual items.

In addition, in the case where image data taken in using the scanner function are to be transmitted to an external address, a list of destination mail lists registered in the setting information is displayed on the display unit 17. This enables the user to select a destination of the image data without inputting a destination to the image forming apparatus 10 in the shared office.

To execute the scanner function using the displayed content, the user operates a start button.

The image forming apparatus 10 confirms with the user using the display unit 17 whether or not to delete the setting information etc. when processing of the specified function is terminated (step 27).

The image forming apparatus 10 deletes the setting information etc. when instructed to delete such information, and displays a home screen when instructed not to (step 28). Returning to the home screen enables the user to select a different function and continue working. In the case where a different function is selected, the processes in and after step 23 are executed for the different selected function.

For example, in the case where the different function is the copy function, whether a copy of a document is output in monochrome or in color, designation of the paper size, the concentration, etc. are displayed on the display unit 17 as the setting information for the temporary user. When the start button is operated, copying is executed using the displayed setting content.

In the case where the different function is a cloud service etc. that requires authentication, an ID, a password, and other authentication information for using the cloud service are applied to the image forming apparatus 10 in addition to the setting information. Also in this case, image data are taken in using the setting information and the authentication information and the image data are transferred to the cloud service when the cloud service to be used is selected and the start button is operated.

In the case where the different function is a net print service that does not require authentication, communication with an external server is executed using a reservation number and a code number acquired from the portable terminal 20 as the setting information to execute net print.

In the case where the different function is a ticket print service that does not require authentication, communication with an external server is executed using a print code for a ticket acquired from the portable terminal 20 as the setting information to print the ticket.

Termination of use of the image forming apparatus 10 by the user is received when the user performs an operation for log-out. The image forming apparatus 10 considers that the user has logged out in the case where a time determined in advance elapses since processing of the function designated by the user is ended.

On the other hand, the management server 30 monitors the period of use of the temporary user and deletes the temporary user after the lapse of the period of use after notifying the image forming apparatus 10 and the portable terminal 20 of the authentication information on the temporary user (step 14). The temporary user may also be deleted from the management server 30 each time use of the image forming apparatus 10 by the user is terminated.

### Second Exemplary Embodiment

In the case of the first exemplary embodiment, it is assumed that the image forming apparatus 10 is notified of the mail address etc. of the portable terminal 20 carried by the user who uses the image forming apparatus 10 to enable direct communication. Therefore, in step 24 (see FIG. 12), a request for setting information related to the activated function is transmitted from the image forming apparatus 10 to the portable terminal 20 as a destination.

However, the image forming apparatus 10 is occasionally not notified of the mail address etc. of the portable terminal 20.

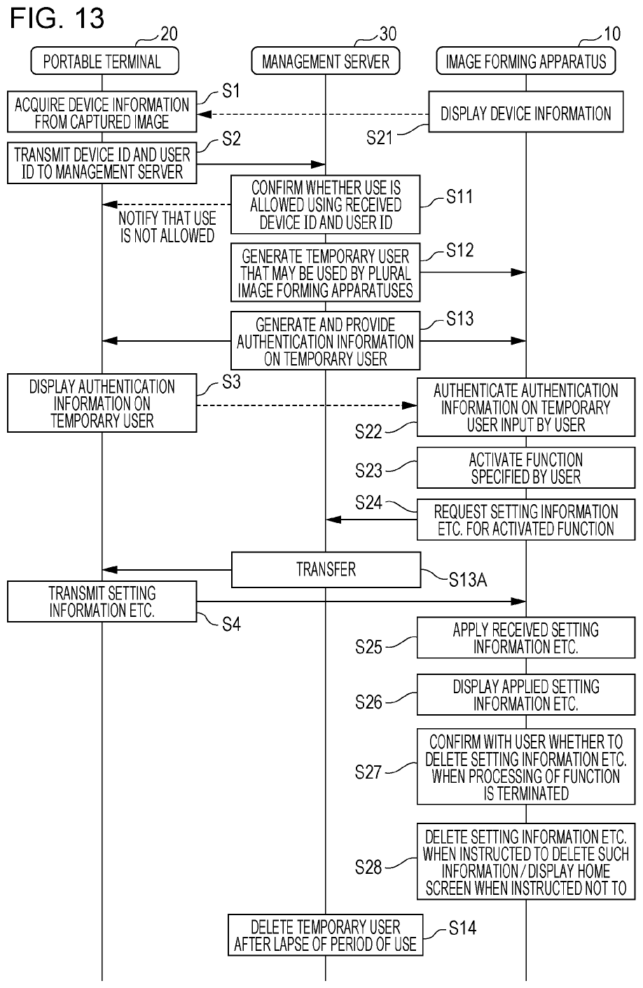

FIG. 13 illustrates processing operation of the management system 1 that is used in the second exemplary embodiment. Portions in FIG. 13 corresponding to those in FIG. 12 are denoted by the corresponding reference numerals.

In the case of the present exemplary embodiment, the image forming apparatus 10 requests the portable terminal 20 for setting information etc. by way of the management server 30. This is because the management server 30 is capable of communication with both the image forming apparatus 10 and the portable terminal 20. If such communication were not possible, communication of authentication information in step 13 would not be possible in the first place.

In the case of FIG. 13, when a request for setting information etc. from the portable terminal 20 is received from the image forming apparatus 10, the management server 30 transfers the received request to the portable terminal 20 as a destination (step 13A).

The processes in and after step 13A are the same as those according to the first exemplary embodiment. The setting information etc. transmitted from the portable terminal 20 may also be transferred to the image forming apparatus 10 by way of the management server 30.

### Third Exemplary Embodiment

In the case of the first exemplary embodiment, the setting information etc. related to the function activated by the user is transmitted from the portable terminal 20 to the image forming apparatus 10. In the present exemplary embodiment, however, a different method related to transmission of the setting information etc. will be described.

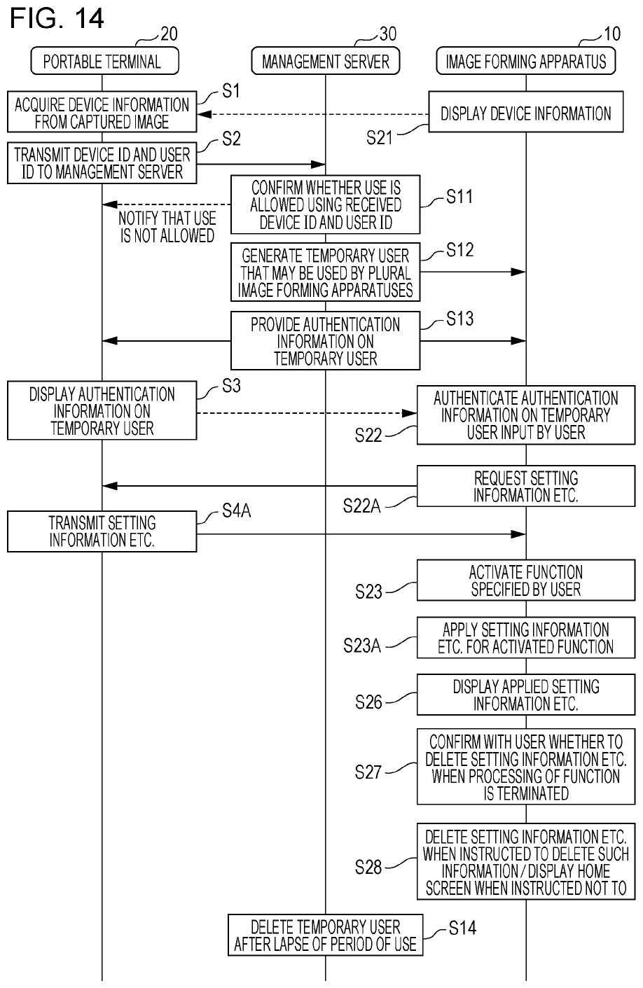

FIG. 14 illustrates processing operation of the management system 1 that is used in the third exemplary embodiment. Portions in FIG. 14 corresponding to those in FIG. 12 are denoted by the corresponding reference numerals.

In the present exemplary embodiment, in the case where use by the user is confirmed through authentication in step 22, the image forming apparatus 10 which has received authentication information requests the portable terminal 20 of the user for setting information etc. (step 22A). In the case of the present exemplary embodiment, no function is specified by the user and no function is activated when such a request is transmitted. Therefore, in the present exemplary embodiment, setting information etc. is requested without specifying a function.

In the case where the image forming apparatus 10 does not have information for accessing the portable terminal 20 of the user, the image forming apparatus 10 requests the portable terminal 20 for setting information etc. by way of the management server 30, as in the second exemplary embodiment.

Upon receiving such a request from the image forming apparatus 10, the portable terminal 20 transmits the setting information etc. to the image forming apparatus 10 which sent the request as a destination (step 4A).

In the case of the present exemplary embodiment, the portable terminal 20 collectively transmits a plurality of pieces of setting information etc. stored in the terminal to the image forming apparatus 10.

In the case where a contract etc. places a constraint on the function that may be used, the portable terminal 20 transmits only the setting information etc. related to the function that the user is permitted to use to the image forming apparatus 10.

In addition, the portable terminal 20 may transmit only specific setting information etc. designated by the user to the image forming apparatus 10 each time a request for setting information etc. is made.

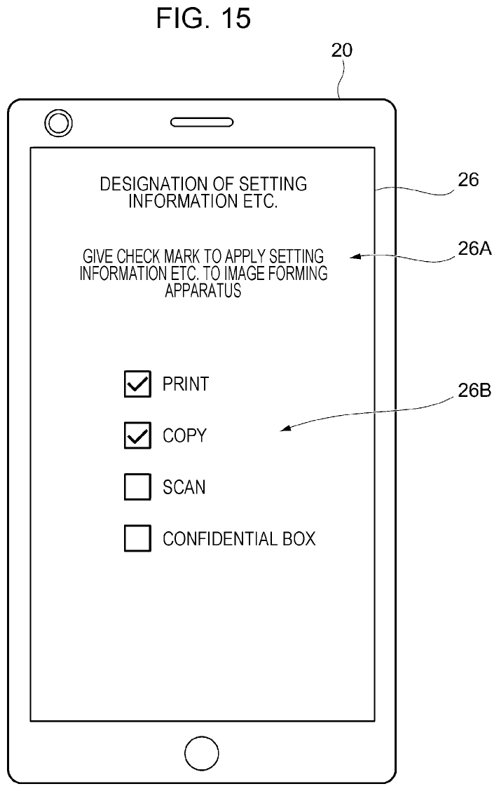

FIG. 15 illustrates an example of a screen displayed on the display unit 26 in the case where setting information etc. to be transmitted to the image forming apparatus is designated.

In the case of FIG. 15, a descriptive statement 26A about an operation for which the user is requested and a list 26B of functions that may be selected for setting information etc. are displayed. In the case of FIG. 15B, a check mark is given to PRINT and COPY. Therefore, only setting information stored for print and copy is transmitted to the image forming apparatus 10.

FIG. 14 is described again. Upon acquiring the setting information etc., the image forming apparatus 10 activates the function specified by the user (step 23), and applies the setting information etc. for the activated function (step 23A). The subsequent processes are the same as those according to the first exemplary embodiment.

### Fourth Exemplary Embodiment

In the case of the first exemplary embodiment, it is confirmed with the user whether or not to delete the setting information etc. each time processing of the function specified by the user is terminated. In the case of the present exemplary embodiment, however, the management server 30 provides an instruction to delete the setting information etc.

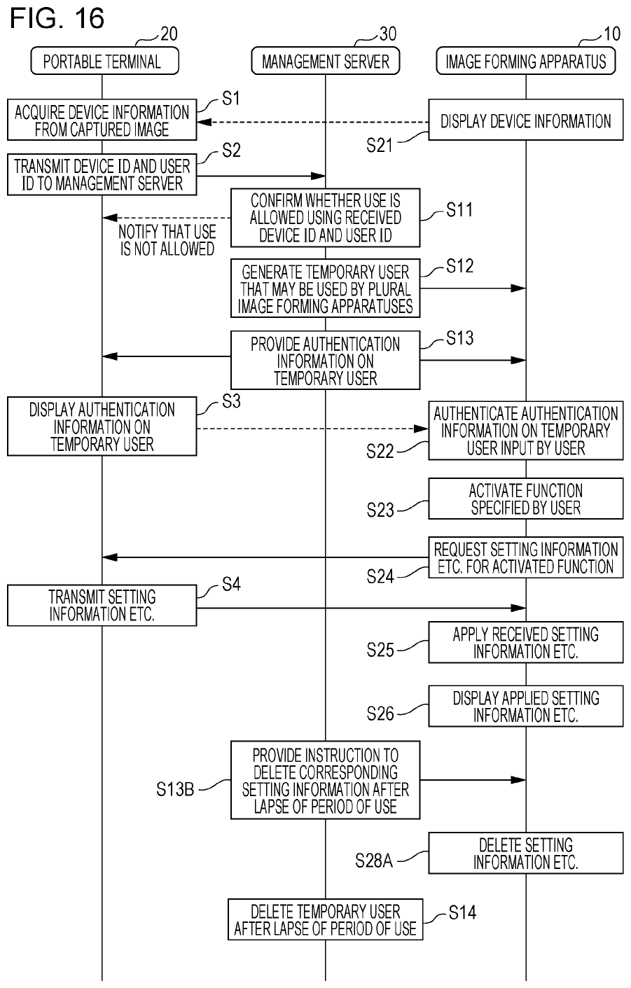

FIG. 16 illustrates processing operation of the management system 1 that is used in the fourth exemplary embodiment. Portions in FIG. 16 corresponding to those in FIG. 12 are denoted by the corresponding reference numerals.

In the case of the present exemplary embodiment, the image forming apparatus 10 does not inquire of the user whether or not to delete the setting information etc. even when processing of the function specified by the user is terminated, and keeps storing the setting information etc. while use of the image forming apparatus 10 by the user is permitted. Therefore, the user is able to read and use the setting information etc. any time during the period of contract. From the viewpoint of security, however, users of the shared office preferably belong to the same company etc.

In the case of the present exemplary embodiment, the management server 30 provides an instruction to delete the corresponding setting information etc. after the lapse of the period of use (step 13B). Upon receiving the instruction, the image forming apparatus 10 deletes the setting information etc. for the user as a target from the storage device 15 (see FIG. 2).

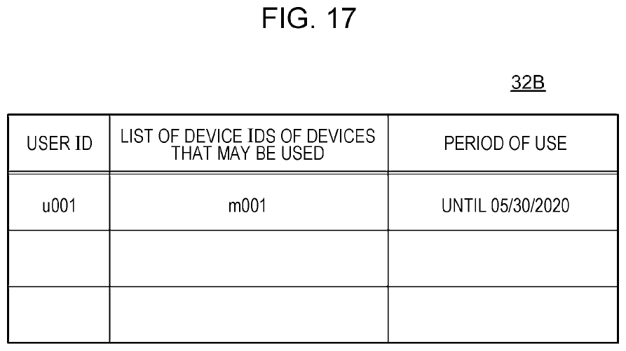

FIG. 17 illustrates another example of the data structure of the registered information 32B on users that may use the devices. In the case of FIG. 17, the registered information 32B stores a period of use in correlation with the user ID. In the example in FIG. 17, “UNTIL May 30, 2020” is stored as the period of use. Therefore, the setting information etc. for this user is deleted from the image forming apparatus 10 in accordance with the instruction from the management server 30 after May 30, 2020.

Information on the temporary user is also deleted from the management server 30 after the lapse of the period of use. The subsequent processes are the same as those according to the first exemplary embodiment.

### Fifth Exemplary Embodiment

In the case of the first exemplary embodiment, the management server 30 notifies both the image forming apparatus 10 and the portable terminal 20 of the authentication information on the temporary user generated in step 13, and the image forming apparatus 10 authenticates the user. In the present exemplary embodiment, however, only the portable terminal 20 is notified of the authentication information.

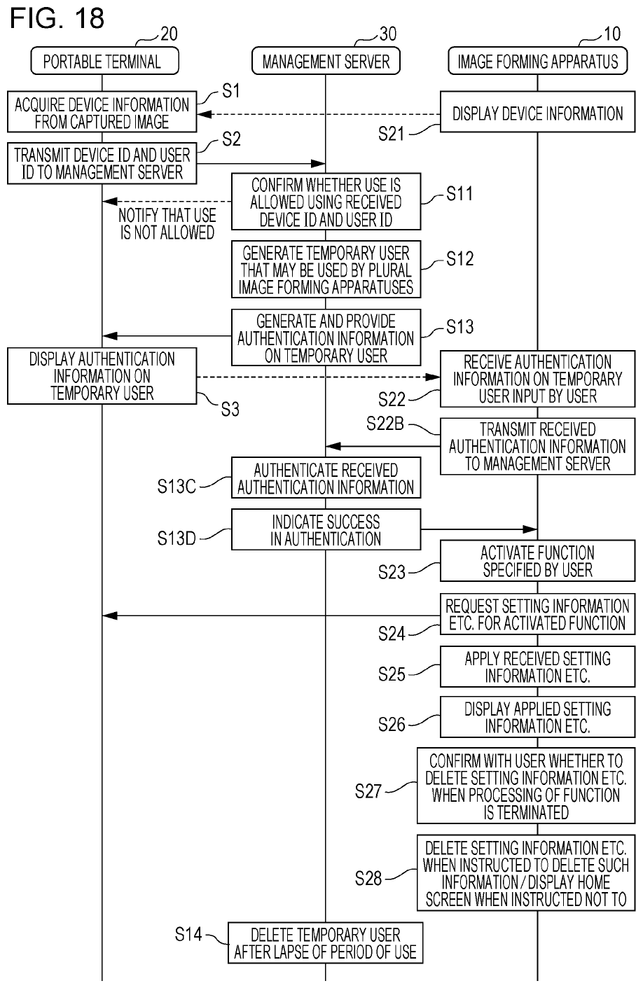

FIG. 18 illustrates processing operation of the management system 1 that is used in the fifth exemplary embodiment. Portions in FIG. 18 corresponding to those in FIG. 12 are denoted by the corresponding reference numerals.

In the case of the present exemplary embodiment, only the portable terminal 20 is notified of the authentication information on the temporary user. Therefore, upon receiving the authentication information on the temporary user input by the user (step 22), the image forming apparatus 20 transmits the received authentication information to the management server 30 (step 22B).

Upon being notified, the management server 30 authenticates the received authentication information (step 13C), and notifies the image forming apparatus 10 of a success in the authentication (step 13D) in the case where the authentication is successfully performed.

The processes after this step are the same as those according to any of the exemplary embodiments discussed earlier. In FIG. 18, the processes according to the first exemplary embodiment are assumed.

### Sixth Exemplary Embodiment

In the case of the first exemplary embodiment, the management server 30 generates a temporary user. In the present exemplary embodiment, however, the image forming apparatus 10 generates a temporary user.

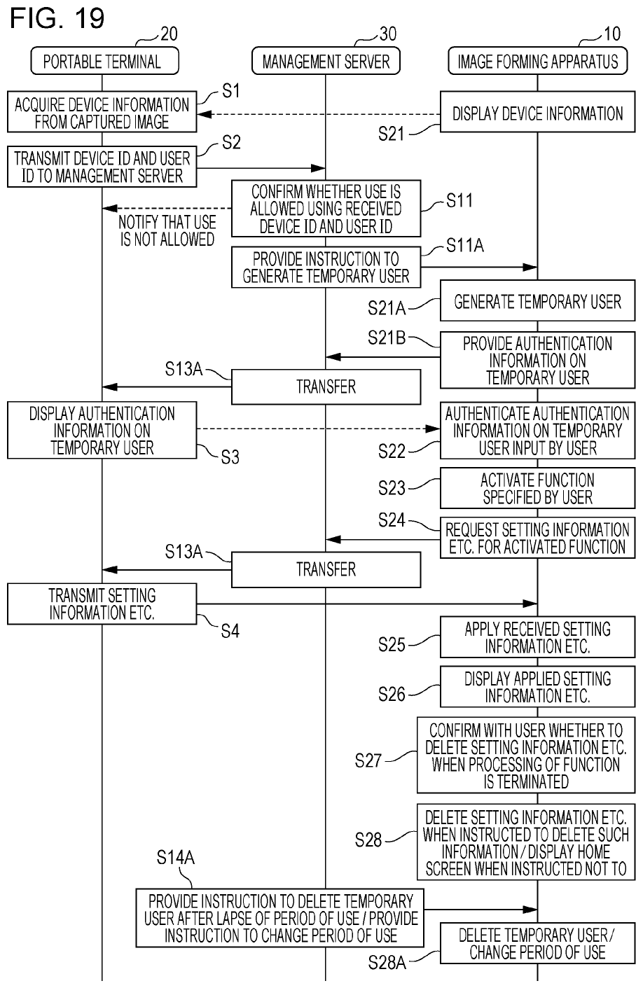

FIG. 19 illustrates processing operation of the management system 1 that is used in the sixth exemplary embodiment. Portions in FIG. 19 corresponding to those in FIG. 12 are denoted by the corresponding reference numerals.

In the case of the present exemplary embodiment, the management server 30 instructs the image forming apparatus 10 specified using the device ID received in step 11 to generate a temporary user (step 11A).

Upon receiving an instruction to generate a temporary user, the image forming apparatus 10 generates a temporary user (step 21A), and also generates authentication information in connection with the generated temporary user. After that, the image forming apparatus 10 notifies the management server 30 of authentication information on the temporary user (step 21B).

Upon receiving a notification, the management server 30 transfers the received authentication information to the portable terminal 20 as a destination (step 13A).

After that, the user inputs the authentication information on the temporary user confirmed with the portable terminal 20 to the image forming apparatus 10.

Also in the case of the present exemplary embodiment, the user is enabled to operate the image forming apparatus 10 once the authentication is successfully performed. When the user designates a specific function, the image forming apparatus 10 requests setting information etc. for the activated function (step 24).

Also in this case, such a request is transferred to the portable terminal 20 by way of the management server 30.

The subsequent processes are the same as those according to the first exemplary embodiment.

In the case of the present exemplary embodiment, however, a temporary user is generated by the image forming apparatus 10. Thus, the management server 30 instructs the image forming apparatus 10 to delete the temporary user after the lapse of the period of use, or to change the period of use (step 14A).

The period of use is changed in the case where the portable terminal 20 notifies the management server 30 of a change in the period of use. The change in the period of use includes shortening and extension of the period of use.

The image forming apparatus 10 deletes the temporary user or changes the period of use in accordance with an instruction from the management server 30 (step 28A).

In the present exemplary embodiment, only a change in the period of use is assumed. However, a change in the service or the function to be used may also be received.

### Seventh Exemplary Embodiment

In the case of the sixth exemplary embodiment, the management server 30 receives a change in the period of use. In the present exemplary embodiment, however, it is assumed that the image forming apparatus 10 receives a change in the period of use.

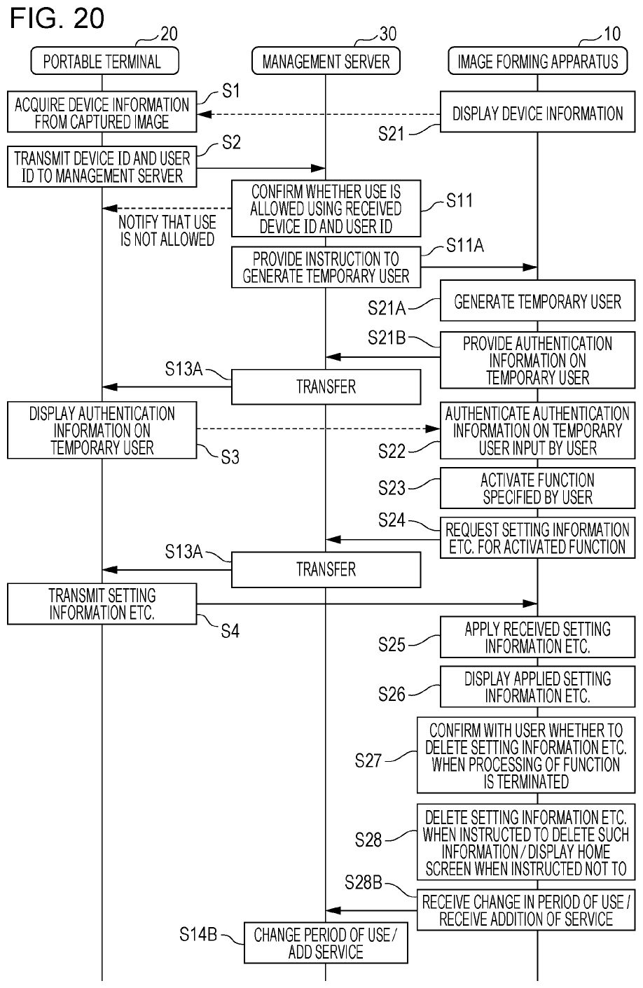

FIG. 20 illustrates processing operation of the management system 1 that is used in the seventh exemplary embodiment. Portions in FIG. 20 corresponding to those in FIG. 19 are denoted by the corresponding reference numerals.

In the case of the present exemplary embodiment, the user provides an instruction to change the period of use by operating the operation reception unit 16 (see FIG. 2) of the image forming apparatus 10.

In the case of FIG. 20, upon receiving a change in the period of use or addition of a service (step 28B), the image forming apparatus 10 notifies the management server 30 of the received change or addition. Deletion of a service may also be received.

The management server 30 changes the period of use or adds the service on the basis of such a notification (step 14B).

### Other Exemplary Embodiments

While exemplary embodiments of the present disclosure have been described above, the technical scope of the present disclosure is not limited to the exemplary embodiments discussed earlier. It is apparent from the following claims that a variety of modifications and improvements that may be made to the exemplary embodiments discussed earlier also fall within the technical scope of the present disclosure.

For example, while an image forming apparatus with a plurality of functions is assumed as a device disposed in a shared office and shared by unspecified users in the exemplary embodiments discussed earlier, such a device may be any device that includes a display section and that is connectable to a network. Examples of such a device include a three-dimensional printer that forms a three-dimensional image using three-dimensional data.

Examples of the network device include a desktop or laptop computer, a dedicated printer, and a dedicated facsimile. Other examples of the network device also include a device that processes an image such as a monitor, a projector, and a camera.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An information processing system comprising:
a network device, use of which by a user is permitted beforehand for a period set beforehand; and
an information processing apparatus that manages first information for identifying the user and second information for identifying the network device in connection with each other,
wherein the information processing apparatus includes a first processor configured to
prepare a temporary account in correlation with the network device corresponding to the second information in a case where an application for use including the first information and the second information is received, and
notify information to be used to authenticate the prepared temporary account to a portable terminal used by the user to make the application, and
the network device includes a second processor configured to
apply operational setting prepared in the portable terminal for the temporary account in a case where the information to be used to authenticate the temporary account is acquired, wherein the information processing apparatus manages registered information that includes a period of use in correlation with the first information.

2. The information processing system according to claim 1,
wherein the first processor is configured to acquire the operational setting for the network device as a target for the application from the portable terminal and apply the operational setting to the network device in a case where the temporary account is prepared.

3. The information processing system according to claim 2,
wherein a range of the operational setting to be applied to the network device is determined in accordance with a function that the user is permitted to use.

4. The information processing system according to claim 2,
wherein a range of the operational setting to be applied to the network device is determined in accordance with a function for which the user made the application through the portable terminal.

5. The information processing system according to claim 2,
wherein the operational setting to be applied to the network device is determined in accordance with a request from the network device.

6. The information processing system according to claim 1,
wherein the first processor is configured to delete the temporary account related to the user in a case where the period for which the use by the user is permitted has elapsed.

7. The information processing system according to claim 6,
wherein the first processor is configured to instruct the network device corresponding to the temporary account to delete the setting.

8. The information processing system according to claim 6,
wherein the first processor is configured to cause a display section of the network device, or a display section of the portable terminal carried by the user, to display a screen that requests confirmation of deletion of the setting from the network device each time the use by the user is terminated, the setting being used in the use by the user.

9. The information processing system according to claim 1,
wherein the second processor is configured to acquire the operational setting for the network device directly from the portable terminal carried by the user, and set the operational setting for the network device.

10. The information processing system according to claim 9,
wherein the second processor is configured to delete the operational setting registered in correlation with the temporary account related to the user in a case where the period for which the use by the user corresponding to the temporary account is permitted has elapsed.

11. The information processing system according to claim 9,
wherein the second processor is configured to cause a display section of the network device, or a display section of the portable terminal carried by the user, to display a screen that requests confirmation of deletion of the setting each time the use by the user is terminated, the setting being used in the use by the user.

12. An information processing system comprising:
a network device, use of which by a user is permitted beforehand for a period set beforehand; and
an information processing apparatus that manages first information for identifying the user and second information for identifying the network device in connection with each other,
wherein the information processing apparatus includes a first processor configured to
instruct the network device corresponding to the second information to prepare a temporary account in a case where an application for use including the first information and the second information is received, and
when information to be used to authenticate the prepared temporary account is received from the network device, notify the received information to a portable terminal used by the user corresponding to the first information to make the application, and
the network device includes a second processor configured to
prepare the temporary account on a basis of an instruction from the information processing apparatus, and
apply operational setting prepared in the portable terminal for the temporary account in a case where the information to be used to authenticate the temporary account is acquired, wherein the information processing apparatus manages registered information that includes a period of use in correlation with the first information.

13. The information processing system according to claim 12,
wherein the second processor is configured to receive a notification of deletion of the temporary account, or a notification of a period for which use of the temporary account is permitted, from the information processing apparatus.

14. The information processing system according to claim 12,
wherein the second processor is configured to manage information related to use of the temporary account on a basis of information included in the instruction to prepare the temporary account.

15. The information processing system according to claim 14,
wherein the second processor is configured to notify, in a case where a change related to use of the temporary account is received, the information processing apparatus of the received change.

16. An information processing system comprising:
a network device, use of which by a user is permitted beforehand for a period set beforehand; and
an information processing apparatus that manages first information for identifying the user and second information for identifying the network device in connection with each other,
wherein the information processing apparatus includes a first processor configured to
prepare a temporary account after management of the first information and the second information is started, and
notify a portable terminal carried by the user of information to be used to authenticate the prepared temporary account, and
the network device includes a second processor configured to
transmit, in a case where the information to be used to authenticate the temporary account is acquired, the acquired information to the information processing apparatus, and
apply operational setting prepared in the portable terminal for the temporary account in a case where a success in authentication is received from the information processing apparatus, wherein the information processing apparatus manages registered information that includes a period of use in correlation with the first information.
